(19) United States
(12) Patent Application Publication
(10) Pub. No.: US 2023/0371515 A1
(43) Pub. Date: Nov. 23, 2023

(54) FUNGICIDAL COMBINATION

(71) Applicant: UPL Limited, Mumbai (IN)

(72) Inventor: Das Kuntal, Mumbai (IN)

(21) Appl. No.: 18/044,234

(22) PCT Filed: Sep. 8, 2021
(86) PCT No.: PCT/IB2021/058167

§ 371 Date: Mar. 7, 2023

(30) Foreign Application Priority Data
Sep. 9, 2020 (IN) 202021029192

(51) Int. Cl. A01N 47/04; A01P 3/00; A01N 43/40; A01N 43/56

(52) U.S. Cl. CPC A01N 47/04; A01P 3/00; A01N 43/40; A01N 43/56

(57) ABSTRACT

The present invention provides fungicide combinations and compositions to improve the spectrum of plant disease control, with the use curative and preventive actives at a lower dosage. More particularly, the present invention provides a fungicidal combination comprising captan and a second fungicide. The present invention further provides methods of controlling and/or suppressing phytopathogenic fungi and maintaining crop health.

### TECHNICAL FIELD

The present invention relates to a combination of fungicides. More specifically, the present invention relates to fungicidal combinations comprising a multisite contact fungicide for controlling a broad spectrum of fungal diseases.

### BACKGROUND OF THE INVENTION

Fungicides are important tools in the fight against plant diseases. They are used not just to protect and control plant fungal diseases but to improve yields and quality of the crops. Various fungicides that have been developed over the years have many desirable attributes such as specificity, systemicity, curative and eradicant action and high activity at low use rates.

Captan is a phthalimide fungicide compound within the multisite contact fungicides. It works with non-systemic manner with protective and curative action. It is known to control a broad spectrum of diseases.

Succinate dehydrogenase inhibitor (SDHI) fungicides are known in the art to be broad spectrum and have a high potency. Pyrazolecarboxamides are a group of active compounds within the SDHI family of fungicides that are known to be more potent than most other SDHI fungicides. These molecules specifically bind to the ubiquinone-binding site (Q-site) of the mitochondrial complex Π, thereby inhibiting fungal respiration. These fungicides are known to control a broad spectrum of fungal diseases.

Various other classes of fungicides are also known in the art, such as Quinone inside inhibitors (QoIs), ergosterol-biosynthesis inhibitors, fungicides that act on multiple sites, fungicides that affect mitosis etc. These fungicides have been mixed with multisite fungicide to achieve a broad spectrum of disease control.

There is a further need in the art for combinations that helps improve spectrum of plant disease control. With crop tolerances decreasing, lower use rates being imposed and resistance being increasingly observed, there is a need for a combination of actives that allows for broader disease control spectrum that combines curative and preventive actives and has a lower dosage.

Therefore, embodiments of the present invention may ameliorate one or more of the abovementioned problems:

### ONE OR MORE OBJECTS OF THE INVENTION

Therefore, embodiments of the present invention may provide combinations of fungicides that possess an enhanced efficacy over the individual fungicides used in isolation.

Another object of the present invention is to provide a fungicidal combination that causes an enhanced greening of the crops to which it is administered.

Yet another object of the present invention is to provide a fungicidal combination that results into reduced fungal disease incidence in the crops to which it is applied.

Another object of the present invention is to provide a fungicidal combination that achieves increased yield in the crops to which it is applied.

Some or all these and other objects of the invention are can be achieved by way of the invention described hereinafter.

### SUMMARY OF THE INVENTION

Thus, an aspect of the present invention provides a fungicidal combination comprising:
a) captan; and
b) at least one second agrochemically active fungicide selected from SDHI (Succinate dehydrogenase inhibitors) and Quinone inside Inhibitors (QII).

In another aspect the present invention provides fungicidal compositions comprising:
a) captan; and
b) at least one second agrochemically active fungicide selected from SDHI (Succinate dehydrogenase inhibitors) and Quinone inside Inhibitors.

In yet another aspect, the present invention provides a method of controlling fungi at a locus, said method comprising applying to the locus at which said fungal control is desired, a fungicidal combination comprising:
a) captan; and
b) at least one second agrochemically active fungicide selected from SDHI (Succinate dehydrogenase inhibitors) and Quinone inside Inhibitors.

### DETAILED DESCRIPTION OF THE INVENTION

The term ‘disease control’ as used herein denotes control and prevention of a disease. Controlling effects include all deviation from natural development, for example: killing, retardation, decrease of the fugal disease. The term ‘plants’ refers to all physical parts of a plant, including seeds, seedlings, saplings, roots, tubers, stems, stalks, foliage and fruits.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “agriculturally acceptable amount of active” refers to an amount of an active that kills or inhibits the plant disease for which control is desired, in an amount not significantly toxic to the plant being treated.

As used herein, according to the Fungicide Resistance Action Committee (FRAC), ‘EC50’ is defined as the fungicide dose that inhibits growth by 50% when compared with a nonamended control.

It has been found that the addition of a SDHI (Succinate dehydrogenase inhibitors) and Quinone inside Inhibitors fungicide such as Inpyrfluxam or fenpicoxamid, respectively or a combination thereof to Captan leads to a synergistic action with broad spectrum control. It was surprising that the addition of a Captan to the SDHI (Succinate dehydrogenase inhibitors) and Quinone inside Inhibitors fungicide resulted in an enhancement of the efficacy, and a surprising reduction in fungal disease incidence, seen only when these actives are combined. As will be demonstrated in the examples, the synergistic effect of the present combination is far superior to the combinations of the prior art.

These surprising advantages of the combinations of the invention were not observed when either captan or either of the SDHI (Succinate dehydrogenase inhibitors) and Quinone inside Inhibitors fungicide were not present in the combination, or when captan was replaced by similar compounds. Therefore, these unexpected advantages of the combination of the present invention have been attributed to synergism between the two active compounds or class of compounds of the present invention.

In an embodiment, the present invention provides a fungicide combination comprising
captan and a fungicide.

In an embodiment, the second fungicide in the fungicide combinations is one or more of a SDHI fungicide (Succinate dehydrogenase inhibitors) and Quinone inside Inhibitors (QII) fungicide.

In an embodiment, the second fungicide is a SDHI fungicide.

In an embodiment, the second fungicide is a Quinone inside Inhibitor fungicide.

Thus, in an embodiment, SDHI (Succinate dehydrogenase inhibitors) is selected from benzovindiflupyr, bixafen, fluindapyr, fluxapyroxad, furametpyr, inpyrfluxam, isopyrazam, penflufen, penthiopyrad, sedaxane, benodanil, flutolanil, mepronil, isofetamid, fluopyram, fenfuram, carboxin, oxycarboxin, thifluzamide, isoflucypram, pydiflumetofen, boscalid and pyraziflumid.

Thus, in an aspect, the present invention provides a fungicidal combination comprising:
(a) captan; and
(b) Inpyrfluxam.

In an aspect, the present invention provides a fungicidal combination comprising:
(a) captan; and
(b) fluindapyr.

In another aspect, the present invention provides a fungicidal combination comprising:
(a) captan; and
(b) fluxapyroxad.

In yet another aspect, the present invention provides a fungicidal combination comprising:
(a) captan; and
(b) bixafen.

In one aspect, the present invention provides a fungicidal combination comprising:
(a) captan; and
(b) benzovindiflupyr.

In an embodiment, the Quinone inside Inhibitor fungicide is selected from one or more of Cyazofamid, amisulbrom and fenpicoxamid.

Thus, in an aspect, the present invention provides a fungicidal combination comprising:
(a) captan; and
(b) fenpicoxamide.

In another aspect, the present invention provides a fungicidal combination comprising:
(a) captan; and
(b) cyazofamid.

In one aspect, the present invention provides a fungicidal combination comprising:
(a) captan; and
(b) amisulbrom.

The combination of the present invention may be used to control a broad spectrum of plant diseases, such as: Disease in rice: Blast (Magnaporthe grisea), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).

Diseases of tomato: early blight (Alternaria solani), leaf mold (Cladosporium fulvum), and late blight (Phytophthora infestans).

Diseases of eggplant: brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion: rust (Puccinia allii), and downy mildew (Peronospora destructor)

Diseases of soybean: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea: powdery mildew (Erysiphe pisi), and root rot (Fusarium solani f. sp. pisi).

Diseases of potato: early blight (Alternaria solani), late blight (Phytophthora infestans), pink rot (Phytophthora erythroseptica), and powdery scab (Spongospora subterranean f. sp. subterranea).

Diseases of strawberry: powdery mildew (Sphaerotheca humuli), and anthracnose (Glomerella cingulata).

Diseases of tea: net blister blight (Exobasidium reticulatum), white scab (Elsinoe leucospila), gray blight (Pestalotiopsis sp.), and anthracnose (Colletotrichum theae-sinensis).

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beet: Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish: Alternaria leaf spot (Alternaria brassicicola).

Diseases of turfgrass: dollar spot (Sclerotinia homeocarpa), and brown patch and large patch (Rhizoctonia solani).

Disease of banana: Black sigatoka (Mycosphaerella fijiensis), Yellow sigatoka (Mycosphaerella musicola).

Disease of sunflower: downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp. and so on.

The combinations and/or compositions of the present invention can be used in agricultural lands such as fields, paddy fields, lawns and orchards or in non-agricultural lands. The present invention may be used to control diseases in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the combination of the present invention may be admixed in ratio of (1-80):(1-80). Preferably, fungicidal combination of the present invention may be admixed in ratios of (1-50):(1-50), (1-40):(1-40). More preferably, the fungicidal combination of the present invention may be admixed in ratios of (1-20):(1-20), (1-10):(1-10), and (1-5):(1-5).

In a preferred embodiment, the fungicidal combination of the present invention may be admixed in a ratio of 1:1.

In an embodiment, the present invention provides a fungicide composition comprising
captan and a second fungicide with one more more agriculturally acceptable excipients/carriers.

In an embodiment, the second fungicide is one or more of a SDHI fungicide (Succinate dehydrogenase inhibitors) and Quinone inside Inhibitors fungicide.

In an embodiment, the second fungicide is a SDHI fungicide.

In an embodiment, the second fungicide is a Quinone inside Inhibitor fungicide.

Thus, in an embodiment, SDHI (Succinate dehydrogenase inhibitors) is selected from benzovindiflupyr, bixafen, fluindapyr, fluxapyroxad, furametpyr, inpyrfluxam, isopyrazam, penflufen, penthiopyrad, sedaxane, benodanil, flutolanil, mepronil, isofetamid, fluopyram, fenfuram, carboxin, oxycarboxin, thifluzamide, isoflucypram, pydiflumetofen, boscalid and pyraziflumid.

Thus, in an aspect, the present invention provides a fungicide composition comprising:
(a) captan; and
(b) Inpyryfluxam.

In an aspect, the present invention provides a fungicide composition comprising:
(a) captan; and
(b) fluindapyr.

In another aspect, the present invention provides a fungicidal composition comprising:
(c) captan; and
(d) fluxapyroxad.

In yet another aspect, the present invention provides a fungicidal composition comprising:
(c) captan; and
(d) bixafen.

In one aspect, the present invention provides a fungicidal composition comprising:
(c) captan; and
(d) benzovindiflupyr.

In an embodiment, the Quinone inside Inhibitor fungicide is selected from one or more of Cyazofamid, amisulbrom and fenpicoxamid.

Thus, in an aspect, the present invention provides a fungicidal composition comprising:
(a) captan; and
(b) fenpicoxamide.

In another aspect, the present invention provides a fungicidal composition comprising:
(c) captan; and
(d) cyazofamid.

In one aspect, the present invention provides a fungicidal composition comprising:
(c) captan; and
(d) amisulbrom.

The composition of the present invention may be used to control a broad spectrum of plant diseases.

In an embodiment, the total amount of Captan in the composition may typically be in the range of 0.1 to 99% by weight, preferably 0.2 to 90% by weight. The total amount of fenpicoxamide in the composition may be in the range of 0.1 to 99% by weight. Alternately, the total amount of inpyryfluxam in the composition may be in the range of 0.1 to 99% by weight of the composition.

In an embodiment, the present invention provides a method of making a synergistic composition for control of phytopathogenic fungal diseases, wherein the method comprises mixing captan and at least a second fungicide selected from one or more of SDHI (Succinate dehydrogenase inhibitors) and/or Quinone inside Inhibitors fungicide.

According to another embodiment, the present invention provides a method of making a synergistic composition for control fungi, wherein the method comprises mixing captan and a second fungicide selected from one or more of Succinate dehydrogenase inhibitors (SDHI) and/or Quinone inside Inhibitors fungicide (QII), wherein said SDHI is Inpyrfluxam and said QII is Fenpicoxamide.

According to an embodiment, captan and the second fungicide may be mixed at the time of application or on the point of application. The point of application refers to the locus of application of the said fungicides. The said locus could be an infected plant or a seed or any other plant propagation material, or an area adjacent to the said infected plant or a seed or any other plant propagation material and/or foliage.

In an embodiment, the constituents of the combination of the present invention may be tank mixed and sprayed at the locus of the infection or may be alternatively be mixed with surfactants and then sprayed.

In an embodiment, the constituents of the combination of the present invention may be used for foliar application, ground or applications to plant propagation materials.

In an embodiment, the combinations of the present invention may typically be produced by mixing the actives in the composition with an inert carrier, and adding surfactants and other adjuvants and carriers as needed and formulated into solid, or liquid formulations, including but not limited to wettable powders, granules, dusts, soluble (liquid) concentrates, suspension concentrates, oil in water emulsion, water in oil emulsion, emulsifiable concentrates, capsule suspensions, ZC formulations, oil dispersions or other known formulation types. The combination may also be used for treatment of a plant propagation material such as seeds etc.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminium magnesium silicate and alumina sol, preservatives, colouring agents and stabilization agents such as PAP (acid phosphate isopropyl) and BHT.

In an aspect, the present invention provides a fungicide combination comprising:
(a) captan,
(b) Quinone inside Inhibitors fungicide, and
(c) at least another agrochemical.

In an aspect, the present invention provides a fungicide combination comprising:
(a) captan;
(b) fenpicoxamide; and
(c) at least another agrochemical.

In an aspect, the present invention provides a fungicide combination comprising:
(a) captan;
(b) SDHI fungicide (Succinate dehydrogenase inhibitors) and
(c) at least another agrochemical.

In an aspect, the present invention provides a fungicide combination comprising:
(a) captan;
(b) inpyrfluxam; and
(c) at least another agrochemical.

In an embodiment, said at least another agrochemical may be selected from a fungicide, insecticide, herbicide, biocide, plant growth regulator, plant activator, fertilizers and the like.

In an embodiment, said at least another agrochemical is a fungicide.

In a preferred embodiment, the fungicide may be a systemic or contact fungicide.

In an embodiment, the optional third fungicide may be selected from morpholine fungicides, triazole fungicides, acylamino acid fungicides, anilide fungicides, antibiotic fungicides, strobilurin fungicides, aromatic fungicides, arsenical fungicides, aryl phenyl ketone fungicides, benzimidazole fungicides, benzimidazole precursor fungicides, benzothiazole fungicides, bridged diphenyl fungicides, carbamate fungicides, conazole fungicides, copper fungicides, dicarboximide fungicides, dinitrophenol fungicides, dithiocarbamate fungicides, dithiolane fungicides, hydrazide fungicides, imidazole fungicides, inorganic fungicides, organophosphorus fungicides, organotin fungicides, oxathiin fungicides, oxazole fungicides, pyrimidine fungicides, pyrrole fungicides, quinoline fungicides, quinone fungicides, quinoxaline fungicides, thiadiazole fungicides, thiazole fungicides, thiazolidine fungicides, thiocarbamate fungicides, thiophene fungicides, triazine fungicides, triazolopyrimidine fungicides, urea fungicides, zinc fungicides, unclassified fungicides and mixtures thereof.

Each of the aspect described herein may have one or more embodiments.

Each of the embodiments described hereinafter may apply to one or all the aspects described elsewhere in the specification. These embodiments are intended to be read as being preferred features of one or all the aspects described hereinabove. Each of the embodiments described hereinafter applies to each of the aspects described hereinabove individually.

In an embodiment, the present invention provides preferred combinations, compositions and methods thereof. The embodiments described herein describe the preferred embodiments of all these possible combinations, compositions and methods of the invention.

In an embodiment, the third fungicide is a morpholine fungicide selected from aldimorph, benzamorph, carbamorph, dimethomorph, dodemorph, fenpropimorph, flumorph or tridemorph.

In an embodiment, the third fungicide is a triazole fungicide selected from amisulbrom, bitertanol, fluotrimazole, triazbutil, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, huanjunzuo, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, or uniconazole-P.

In an embodiment, the third fungicide is an acylamino acid fungicide selected from benalaxyl, benalaxyl-M, furalaxyl, metalaxyl, metalaxyl-M, pefurazoate, or valifenalate.

In an embodiment, the third fungicide is an anilide fungicide selected from benalaxyl, benalaxyl-M, bixafen, boscalid, carboxin, fenhexamid, fluxapyroxad, isotianil, metalaxyl, metalaxyl-M, metsulfovax, ofurace, oxadixyl, oxycarboxin, penflufen, pyracarbolid, pyraziflumid, sedaxane, thifluzamide, tiadinil, or vangard.

In an embodiment, the third fungicide is an antibiotic fungicide selected from aureofungin, blasticidin-S, cycloheximide, griseofulvin, kasugamycin, moroxydine, natamycin, polyoxins, polyoxorim, streptomycin, or validamycin.

In an embodiment, the third fungicide is a strobilurin fungicide selected from fluoxastrobin, mandestrobin, pyribencarb, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, or trifloxystrobin.

In an embodiment, the third fungicide is an aromatic fungicide selected from biphenyl, chlorodinitronaphthalenes, chloroneb, chlorothalonil, cresol, dicloran, fenjuntong, hexachlorobenzene, pentachlorophenol, quintozene, sodium pentachlorophenate, tecnazene, thiocyanatodinitrobenzenes, or trichlorotrinitrobenzenes.

In an embodiment, the third fungicide is an arsenical fungicide selected from asomate or urbacide.

In an embodiment, the third fungicide is an aryl phenyl ketone fungicide selected from metrafenone or pyriofenone.

In an embodiment, the third fungicide is a benzimidazole fungicide selected from elbendazole, benomyl, carbendazim, chlorfenazole, cypendazole, debacarb, fuberidazole, mecarbinzid, rabenzazole, or thiabendazole.

In an embodiment, the third fungicide is a benzimidazole precursor fungicide selected from furophanate, thiophanate or thiophanate-methyl.

In an embodiment, the third fungicide is a benzothiazole fungicide selected from bentaluron, benthiavalicarb, benthiazole, chlobenthiazone, dichlobentizox, or probenazole.

In an embodiment, the third fungicide is a bridged diphenyl fungicide selected from bithionol, dichlorophen, diphenylamine, hexachlorophene, and parinol.

In an embodiment, the third fungicide is a carbamate fungicide selected from benthiavalicarb, furophanate, iodocarb, iprovalicarb, picarbutrazox, propamocarb, pyribencarb, thiophanate, thiophanate-methyl, tolprocarb, albendazole, benomyl, carbendazim, cypendazole, debacarb, mecarbinzid, diethofencarb, pyraclostrobin, pyrametostrobin, and triclopyricarb.

In an embodiment, the third fungicide is a conazole fungicide selected from climbazole, clotrimazole, imazalil, oxpoconazole, prochloraz, trilfumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole, uniconazole and uniconazole-P.

In an embodiment, the third fungicide is a copper fungicide selected from acypetacs-copper, basic copper carbonate, basic copper sulfate, Bordeaux mixture, Burgundy mixture, Cheshunt mixture, copper acetate, copper hydroxide, copper naphthenate, copper oleate, copper oxychloride, copper silicate, copper sulfate, copper zinc chromate, cufraneb, cuprobam, cuprous oxide, mancopper, oxine-copper, saisentong, or thiodiazole-copper.

In an embodiment, the third fungicide is a dicarboximide fungicide selected from famoxadone, fluoroimide, chlozolinate, dichlozoline, iprodione, isovaledione, myclozolin, procymidone, vinclozolin, captafol, captan, ditalimfos, folpet or thiochlorfenphim.

In an embodiment, the third fungicide is a dinitrophenol fungicide selected from binapacryl, dinobuton, dinocap, dinocap-4, dinocap-6, meptyldinocap, dinocton, dinopenton, dinosulfon, dinoterbon or Dinitro-ortho-cresol (DNOC).

In an embodiment, the third fungicide is a dithiocarbamate fungicide selected from amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb or zineb.

In an embodiment, the third fungicide is a dithiolane fungicide selected from isoprothiolane or saijunmao.

In an embodiment, the third fungicide is a hydrazide fungicide selected from benquinox or saijunmao.

In an embodiment, the third fungicide is an imidazole fungicide selected from cyazofamid, fenamidone, fenapanil, glyodin, iprodione, isovaledione, pefurazoate, triazoxide, climbazole, clotrimazole, imazalil, oxpoconazole, prochloraz or triflumizole.

In an embodiment, the third fungicide is an inorganic fungicide selected from potassium azide, potassium thiocyanate, sodium azide, sulfur, mercuric chloride, mercuric oxide, mercurous chloride, (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulfonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, or tolylmercury acetate.

In an embodiment, the third fungicide is an organophosphorus fungicide selected from ampropylfos, ditalimfos, EBP, edifenphos, fosetyl, hexylthiofos, inezin, iprobenfos, izopamfos, kejunlin, phosdiphen, pyrazophos, tolclofos-methyl or triamiphos.

In an embodiment, the third fungicide is an organotin fungicide selected from decafentin, fentin or tributyltin oxide.

In an embodiment, the third fungicide is an oxathiin fungicide selected from carboxin or oxycarboxin.

In an embodiment, the third fungicide is an oxazole fungicide selected from chlozolinate, dichlozoline, drazoxolon, famoxadone, hymexazol, metazoxolon, myclozolin, oxadixyl, oxathiapiprolin, pyrisoxazole or vinclozolin.

In an embodiment, the third fungicide is a pyrimidine fungicide selected from bupirimate, diflumetorim, dimethirimol, ethirimol, fenarimol, ferimzone, nuarimol, triarimol, cyprodinil, mepanipyrim or pyrimethanil.

In an embodiment, the third fungicide is a pyrrole fungicide selected from dimetachlone, fenpiclonil, fludioxonil or fluoroimide.

In an embodiment, the third fungicide is a quinoline fungicide selected from ethoxyquin, halacrinate, 8-hydroxyquinoline sulfate, ipflufenoquin, quinacetol, quinofumelin, quinoxyfen or tebufloquin.

In an embodiment, the third fungicide is a quinone fungicide selected from chloranil, dichlone or diathianon.

In an embodiment, the third fungicide is a quinoxaline fungicide selected from chinomethionat, chlorquinox or thioquinox.

In an embodiment, the third fungicide is a thiadiazole fungicide selected from etridiazole, saisentong, thiodiazole-copper, or zinc thiazole.

In an embodiment, the third fungicide is a thiazole fungicide selected from dichlobentiazox, ethaboxam, isotianil, metsulfovax, octhilinone, oxathiapiprolin, thiabendazole or thifluzamide.

In an embodiment, the third fungicide is a thiazolidine fungicide selected from flutianil or thiadifluor.

In an embodiment, the third fungicide is a thiocarbamate fungicide selected from methasulfocarb or prothiocarb.

In an embodiment, the third fungicide is a thiophene fungicide selected from ethaboxam, isofetamid or silthiofam.

In an embodiment, the third fungicide is anilazine.

In an embodiment, the third fungicide is a triazolopyrimidine fungicide selected from ametoctradin.

In an embodiment, the third fungicide is a urea fungicide selected from bentaluron, pencycuron, or quinazamid.

In an embodiment, the third fungicide is a zinc fungicide selected from acypetacs-zinc, copper zinc chromate, cufraneb, mancozeb, metiram, polycarbamate, polyoxorim-zinc, propineb, zinc naphthenate, zinc thiazole, zinc trichlorophenate, zineb, or ziram.

In an embodiment, the third fungicide is an unclassified fungicide selected from acibenzolar, acypetacs, allyl alcohol, benzalkonium chloride, bethoxazin, bromothalonil, chitosan, chloropicrin, DBCP, dehydroacetic acid, diclomezine, diethyl pyrocarbonate, dipymetitrone, ethylicin, fenaminosulf, fenitropan, fenpropidin, formaldehyde, furfural, hexachlorobutadiene, methyl isothiocyanate, nitrostyrene, nitrothal-isopropyl, OCH, pentachlorophenyl laurate, 2-phenylphenol, phthalide, piperalin, propamidine, proquinazid, pyroquilon, sodium o-phenylphenoxide, spiroxamine, sultropen, thicyofen or tricyclazole.

In an aspect, the present invention may provide compositions comprising:
(a) captan;
(b) fenpicoxamide and
(c) at least another agrochemical active ingredient.

In an aspect, the present invention may provide compositions comprising:
(a) captan;
(b) inpyrfluxam; and
(c) at least another agrochemical active ingredient.

The third active ingredient according to the present embodiment may be selected as defined in the previous aspect of the invention.

In an embodiment, said at least another agrochemical may be selected from a fungicide, insecticide, herbicide, biocide, plant growth regulator, plant activator, fertilizers and the like.

In an embodiment, said agrochemical active ingredient is a fungicide.

In a preferred embodiment, the fungicide may be a systemic or contact fungicide.

In an embodiment, the optional third fungicide may be selected from morpholine fungicides, triazole fungicides, acylamino acid fungicides, anilide fungicides, antibiotic fungicides, strobilurin fungicides, aromatic fungicides, arsenical fungicides, aryl phenyl ketone fungicides, benzimidazole fungicides, benzimidazole precursor fungicides, benzothiazole fungicides, bridged diphenyl fungicides, carbamate fungicides, conazole fungicides, copper fungicides, dicarboximide fungicides, dinitrophenol fungicides, dithiocarbamate fungicides, dithiolane fungicides, hydrazide fungicides, imidazole fungicides, inorganic fungicides, organophosphorus fungicides, organotin fungicides, oxathiin fungicides, oxazole fungicides, pyrimidine fungicides, pyrrole fungicides, quinoline fungicides, quinone fungicides, quinoxaline fungicides, thiadiazole fungicides, thiazole fungicides, thiazolidine fungicides, thiocarbamate fungicides, thiophene fungicides, triazine fungicides, triazolopyrimidine fungicides, urea fungicides, zinc fungicides, unclassified fungicides and mixtures thereof.

In an embodiment, the present invention may provide a composition comprising captan; SDHI (Succinate dehydrogenase inhibitors) or Quinone inside Inhibitors fungicide or a combination thereof; and at least a triazole fungicide.

In an embodiment, the present invention may provide a composition comprising captan; fenpicoxamide or Inpyrfluxam; and at least a triazole fungicide.

In an embodiment, the present invention may provide a composition comprising captan; SDHI (Succinate dehydrogenase inhibitors) or Quinone inside Inhibitors fungicide; and at least a strobilurin fungicide.

In an embodiment, the present invention may provide a composition comprising captan; fenpicoxamide or Inpyrfluxam; and at least a strobiliurin fungicide.

In an embodiment, the present invention may provide a composition comprising captan; SDHI (Succinate dehydrogenase inhibitors) or Quinone inside Inhibitors fungicide; and at least a benzimidazole fungicide.

In an embodiment, the present invention may provide a composition comprising captan; fenpicoxamide or Inpyrfluxam; and at least a benzimidazole fungicide.

In an aspect, the present invention may provide a method of controlling fungal diseases, said method comprising applying to the locus an agrochemically acceptable amount of a combination or a composition comprising:
(a) captan; and
(b) SDHI (Succinate dehydrogenase inhibitors) or Quinone inside Inhibitors fungicide.

In an embodiment, the present invention provides a method of controlling fungal diseases, said method comprising applying to the locus an agrochemically acceptable amount of a combination or a composition comprising:
(a) captan; and
(b) fenpicoxamide.

In another embodiment, the present invention provides a method of controlling fungal diseases, said method comprising applying to the locus an agrochemically acceptable amount of a combination or a composition comprising:
(a) captan; and
(b) inpyrfluxam.

In yet another embodiment, the present invention may provide a method of controlling fungal diseases, said method comprising applying to the locus an agrochemically acceptable amount of a combination or a composition comprising:
(a) captan; and
(b) SDHI (Succinate dehydrogenase inhibitors) or Quinone inside Inhibitors fungicide, wherein said combination is used at a rate of 40 g/ha to 2000 g/ha.

Thus, in an aspect, the present invention may provide a method of resistance management comprising application at the locus of the infection a combination comprising captan and fenpicoxamide or inpyrfluxam.

In an embodiment, the present invention may provide a method of preventing resistance in fungi, said method comprising applying to the locus of the plant, a combination comprising captan and fenpicoxamide or inpyrfluxam.

The combinations of the present invention may be provided as a pre-mix composition or a kit of parts such that individual actives may be mixed before spraying. Alternatively, the kit of parts may contain captan and fenpicoxamide or inpyrfluxam or a combination thereof pre-mixed and the optional third active may be admixed with an adjuvant such that the two components may be tank mixed before spraying.

Therefore, in an aspect, the present invention provides a kit comprising a fungicidal combination comprising captan and fenpicoxamide or inpyrfluxam.

In another aspect, the present invention provides a kit comprising a fungicidal combination comprising captan and fenpicoxamide or inpyrfluxam; and a third fungicide selected from morpholine fungicides, triazole fungicides, acylamino acid fungicides, anilide fungicides, antibiotic fungicides, strobilurin fungicides, aromatic fungicides, arsenical fungicides, aryl phenyl ketone fungicides, benzimidazole fungicides, benzimidazole precursor fungicides, benzothiazole fungicides, bridged diphenyl fungicides, carbamate fungicides, conazole fungicides, copper fungicides, dicarboximide fungicides, dinitrophenol fungicides, dithiocarbamate fungicides, dithiolane fungicides, hydrazide fungicides, imidazole fungicides, inorganic fungicides, organophosphorus fungicides, organotin fungicides, oxathiin fungicides, oxazole fungicides, pyrimidine fungicides, pyrrole fungicides, quinoline fungicides, quinone fungicides, quinoxaline fungicides, thiadiazole fungicides, thiazole fungicides, thiazolidine fungicides, thiocarbamate fungicides, thiophene fungicides, triazine fungicides, triazolopyrimidine fungicides, urea fungicides, zinc fungicides, unclassified fungicides and mixtures thereof.

In another aspect, the present invention provides a kit comprising a fungicidal combination comprising captan and fenpicoxamide or inpyrfluxam; and at least a triazole fungicide.

In another aspect, the present invention provides a kit comprising a fungicidal combination comprising captan and fenpicoxamide or inpyrfluxam; and at least a strobiliurin fungicide.

In another aspect, the present invention provides a kit comprising a fungicidal combination comprising captan and fenpicoxamide or inpyrfluxam and at least a benzimidazole fungicide.

The composition of the present invention maybe applied simultaneously as a tank mix or a formulation or may be applied sequentially. The application may be made to the soil before emergence of the plants, either pre-planting or post-planting. The application may be made as a foliar spray at different timings during crop development, with either one or two applications early or late post-emergence.

The compositions according to the invention can be applied before or after infection of the useful plants or the propagation material thereof by the fungi.

The combination of a captan with fenpicoxamide or inpyrfluxam, greatly improved the disease control as well as improved yield and demonstrated a synergistic effect. The lower the mixture performance in the disease control, the greater the additional benefit of the present invention.

In an aspect, the present invention provides the use of a fungicide combination/5 composition for controlling a broad spectrum of fungal diseases, said combination or composition comprising:
(a) captan; and
(b) SDHI (Succinate dehydrogenase inhibitors) or Quinone inside Inhibitors fungicide.

In an aspect, the present invention provides the use of a fungicide combination/composition for preventing resistance in fungi, said combination or composition comprising:
(a) captan; and
(b) SDHI (Succinate dehydrogenase inhibitors) or Quinone inside Inhibitors fungicide.

Moreover, it was observed that the combination of captan with one or more SDHI and QII was required at lower concentration to inhibit fungi compared to captan or SDHI/QII when used individually to control or inhibit phytopathogenic fungi. Therefore, indicating the superior advantage of the combination of captan and one or more of SDHI and QII in fungal disease control and inhibition.

The invention should not be limited by the above described embodiments and methods, but by all embodiments and methods within the scope and spirit of the invention.

### Example 1

Trials were performed to evaluate the fungicidal efficacy of the present combination of captan and fenpicoxamide on Botrytis cinerea.

TABLE 1

| Treatment | | Formulation | Concentrations |
|---|---|---|---|
| no. | Treatment | Conc. | used |
| 1. | Captan | 500.000 mg/L | 0.01 mg/L |
| 2. | Fenpicoxamide | 130.000 mg/L | 0.01 mg/L |
| 3. | Captan + Fenpicoxamide | 500.000 mg/L + | 0.01 mg/L |
| | | 130.000 mg/L | |

Colby's equation was used to determine the fungicidal effects expected from the mixtures. The following equation was used to calculate the expected activity of mixtures containing two active ingredients, A and B:

Expected=A+B−(A×B/100)
A=observed efficacy of active component A at the same concentration as used in the mixture;
B=observed efficacy of active component B at the same concentration as used in the mixture.

The % control observed with Synergistic mixtures of Captan and Fenpicoxamide in applications against Botrytis cinerea is represented in the table below.

TABLE 2

| Treatment | Concentration | % control |
|---|---|---|
| Captan | 0.01 (mg/L) | 11.54 |
| Fenpicoxamide | 0.01 (mg/L) | 15.45 |
| Captan + Fenpicoxamide | 0.01 (mg/L) | 37.65 |
| (Observed efficacy-O) | | |
| Calculated Expected | — | 25.21 |
| efficacy(E) | | |
| Colby's difference (O-E) | — | 12.44 |
| Conclusion | — | Synergism |

### Example 2

The EC50 values were evaluated to determine a lower concentration of the fungicides and the combination to achieve in vitro inhibition of 50% of fungal population of spores of Botrytis cinerea.

TABLE 3

| Treatment | EC50 (mg/L) |
|---|---|
| Captan | 0.15 |
| Fenpicoxamide | 0.46 |
| Captan + Fenpicoxamide | 0.076 |

The EC50 values indicated that the synergistic mixture of Captan and Fenpicoxamide results in 50% inhibition of the fungal population at a concentration of 0.076 mg/L.

### Advantages of the Invention

The invention should not be limited by the below described advantages.

The present fungicide combinations are synergistic and prove to have efficient % disease control.

The present synergistic combinations of captan and one or more SDHI or QII helps to improve the spectrum of plant disease control, with the use curative and preventive actives and has a lower dosage rate.

The lower EC50 value for the present fungicide combinations compared to individual fungicides helps in applying lower use rates of the combination.

1. A fungicidal combination comprising captan and a second fungicide selected from succinate dehydrogenase inhibitor fungicides (SDHI), quinone inside inhibitors fungicides (QII), and combinations thereof.

2. The fungicidal combination as claimed in claim 1, wherein the SDHI is selected from benzovindiflupyr, bixafen, fluindapyr, fluxapyroxad, furametpyr, inpyrfluxam, isopyrazam, penflufen, penthiopyrad, sedaxane, benodanil, flutolanil, mepronil, isofetamid, fluopyram, fenfuram, carboxin, oxycarboxin, thifluzamide, isoflucypram, pydiflumetofen, boscalid, pyraziflumid, and combinations thereof.

3. The fungicidal combination as claimed in claim 1, wherein the QII fungicide is selected from cyazofamid, amisulbrom and fenpicoxamide, and combinations thereof.

4. The fungicidal combination as claimed in claim 1, wherein a ratio of captan and the SDHI, QII, or combination thereof is is the range of 1:80 to 1:80.

5. The fungicidal combination as claimed in claim 1, wherein said fungicidal combination comprises
(a) captan, and
(b) inpyrfluxam.

6. The fungicidal combination as claimed in claim 1, wherein said fungicidal combination comprises
(a) captan, and
(b) fenpicoxamide.

7. A fungicidal composition comprising captan and a second fungicide selected from SDHI fungicides, QII fungicides, and combinations thereof, wherein the SDHI is selected from one or more of benzovindiflupyr, bixafen, fluindapyr, fluxapyroxad, furametpyr, inpyrfluxam, isopyrazam, penflufen, penthiopyrad, sedaxane, benodanil, flutolanil, mepronil, isofetamid, fluopyram, fenfuram, carboxin, oxycarboxin, thifluzamide, isoflucypram, pydiflumetofen, boscalid, pyraziflumid, and combinations thereof, and and wherein the QII fungicide is selected from cyazofamid, amisulbrom, fenpicoxamide, and combinations thereof.

8. The fungicidal composition as claimed in claim 7, wherein said fungicidal composition comprises
(a) captan, and
(b) inpyrfluxam.

9. The fungicidal composition as claimed in claim 7, wherein said fungicidal composition comprises
(a) captan, and
(b) fenpicoxamide.

10. The fungicidal composition as claimed in claim 7, wherein the concentration of captan is 0.1 to 99% based on the total weight of the composition.

11. The fungicidal combination as claimed in claim 7, wherein the concentration of the second fungicide is 0.1 to 99% based on the total weight of the composition.

12. The composition as claimed in claim 7, wherein said composition further comprises at least one agrochemically acceptable carrier.

13. A method of making a synergistic composition for control of phytopathogenic fungal diseases, wherein the method comprises mixing the combination of claim 1.

14. A method of controlling fungal diseases, said method comprising applying to the locus an agrochemically acceptable amount of the combination of claim 1.

15. The method of controlling fungal diseases as claimed in claim 14,
wherein the second fungicide selected is fenpicoxamide, inpyrfluxam, or a combination thereof.

16. (canceled)

17. A kit-of-parts comprising a first component of captan and a second component of inpyrfluxam, fenpicoxamide, or a combination thereof.

18. The kit-of-parts as claimed in claim 17, wherein said kit-of-parts further comprises one or more additional components comprising one or more active and/or inactive ingredients.

19. The kit-of-parts as claimed in claim 18, wherein said kit-of-parts produces a synergistic mixture when the two components are combined together.
